(19) United States
(12) Patent Application Publication
(10) Pub. No.: US 2011/0110289 A1
(43) Pub. Date: May 12, 2011

(54) DISTRIBUTED CONTROL ARCHITECTURE FOR RELAYS IN BROADBAND WIRELESS NETWORKS

(76) Inventors: Muthaiah Venkatachalam, Beaverton, OR (US); Xiangying Yang, Portland, OR (US); Jaroslaw Sydir, San Jose, CA (US); Avishay Sharaga, Bet Nehemya (IL); Shanidev Mohanty, Santa Clara, CA (US)

(21) Appl. No.: 12/889,938

(22) Filed: Sep. 24, 2010

Related U.S. Application Data
(60) Provisional application No. 61/259,086, filed on Nov. 6, 2009.

(51) Int. Cl. H04B 7/14

(52) U.S. Cl. 370/315

(57) ABSTRACT

Embodiments of systems and methods for distributed control relay architecture are described herein. Other embodiments may be described and claimed.

### CLAIM OF PRIORITY

The present application claims priority to U.S. patent application Ser. No. 61/259,086, filed Nov. 6, 2009, the entire disclosure of which is hereby incorporated by reference in its entirety.

### FIELD OF THE INVENTION

This application relates to wireless systems and, more particularly, to providing a distributed control architecture for wireless relays.

### BACKGROUND

A wireless communications system typically has base stations distributed throughout an area to provide data connectivity throughout the area or cell. Each base station connects through a communications infrastructure to a communications backbone to connect subscribers to other users and systems inside and outside the wireless communications system.

A conventional base station is configured to communicate within the cell or, sometimes, a macrocell of the wireless system. A macrocell provided by the base station may have a cross-section of several miles, however costs and implementation complexity related to base station installation can be considerable. Microcells are used to extend the range of a wireless system beyond the reach of a base station at lower cost than a typical base station, but a range of the microcell is very limited with a cross-section of a hundred feet or less. Repeaters have also been used to extend the range of the wireless system, however the repeaters amplify interference and can degrade signal-to-interference plus noise ratio' (SINR) measured at a receiver. Further, the repeaters generally have no intelligence of signal control and processing in the wireless system.

### BRIEF DESCRIPTION OF THE DRAWINGS

The present invention is illustrated by way of example and not as a limitation in the figures of the accompanying drawings, in which:

FIG. 1 is a diagram that illustrates a wireless network according to some embodiments;

FIG. 2 is a schematic that illustrates a wireless network according to some embodiments;

FIG. 3 is a diagram illustrating a distributed control relay architecture according to some embodiments;

FIG. 4 is a diagram illustrating a protocol stack according to some embodiments;

FIG. 5 is a diagram illustrating a distributed control relay architecture according to some embodiments;

FIG. 6 is a diagram illustrating a method of distributed relay control according to some embodiments, and;

FIG. 7 is a diagram illustrating a method of distributed relay control according to some embodiments.

### DETAILED DESCRIPTION

In the following detailed description, numerous specific details are set forth in order to provide a thorough understanding of embodiments of the invention. However it will be understood by those skilled in the art that embodiments of the invention may be practiced without these specific details. In other instances, well-known methods, procedures, components and circuits have not been described in detail so as not to obscure embodiments of the invention.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices. In addition, the term “plurality” may be used throughout the specification to describe two or more components, devices, elements, parameters and the like.

The following detailed description also describes various embodiments for accessing a wireless network by a wireless device, platform, user equipment (UE), subscriber station (SS), station, mobile station (MS) or advanced mobile station (AMS).

The various forms of devices such as the platform, UE, SS, MS, or MS are generically referred to throughout the specification as a MS. The MS may access the wireless network through one or more devices or systems such as a relay station (RS), an advanced relay station (ARS), base station (BS), advanced base station (ABS), multi-hop relay base station (MRBS), access point (AP), node, relay node (RN), node B, or enhanced node B (eNB). The terms AR and ARS are generically referred to as an AR through the specification and the terms may be conceptually interchanged, depending on which wireless protocol is being used in a particular wireless network. The terms BS, ABS, MRBS, AP, node, node B, or eNB are generically referred to throughout the specification as a BS. Further, the terms BS, ABS, MRBS, AP, node, node B, or eNB may be conceptually interchanged, depending on which wireless protocol is being used in a particular wireless network, so a reference to BS herein may also be considered a reference to either of eNB or AP as one example. Similarly, a reference to MS or SS herein may also be seen as a reference to either of UE or STA as another example. Wireless networks specifically include, but are not limited to, wireless local area networks (WLANs), wireless personal area networks (WPANs), and/or wireless wide area networks (WWANs).

The following inventive embodiments may be used in a variety of applications including a transceiver or transmitters and receivers of a radio system, although the present invention is not limited in this respect. Radio systems specifically included within the scope of the present invention include, but are not limited to, network interface cards (NICs), network adaptors, MS, BS, gateways, bridges, and hubs. Further, the radio systems within the scope of the invention may include cellular radiotelephone systems, satellite systems, personal communication systems (PCS), smartphones, netbooks, two-way radio systems, two-way pagers, personal computers (PCs) and related peripherals, personal digital assistants (PDAs), personal computing accessories and all existing and future arising systems which may be related in nature and to which the principles of the inventive embodiments could be suitably applied.

In the field of communications, including wireless communications, it would be helpful to provide a system and methods for the use of a RS in a wireless network. A RS can provide access to an access services network (ASN) or other network through a connection comprising one or more base stations, advanced base stations (ABS), and other RS. It would be useful to employ one or more RS in a wireless network to gain network coverage extension, to avoid coverage holes in deployment areas, and to provide throughput enhancement in the wireless network. Examples of distributed control architecture and methods to implement control and data path operations incorporating relays in a wireless network are provided in various embodiments of the invention.

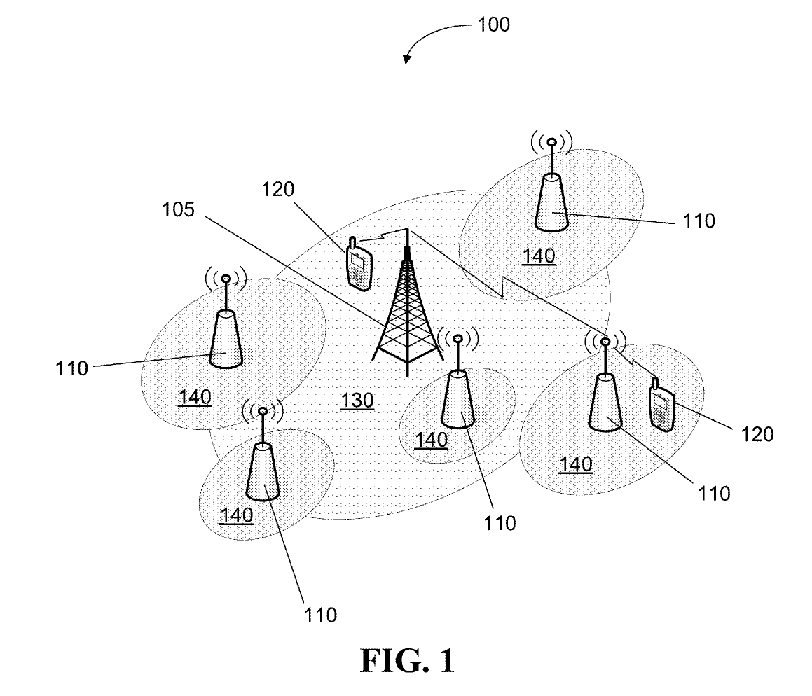

Reference is made to FIG. 1, which illustrates a wireless network 100 according to some embodiments. The wireless network 100 in FIG. 1 is illustrated comprising a serving base station 105 surrounded by five RS 110 and two MS 120, however the embodiment isn't so limited and the wireless network 100 may comprise any number of MS 120, RS 110, and BS 105.

The RS 110 transmit and receive signals to and from the serving base station 105 and/or to other RS 110 and/or to MS 120 using a transceiver and one or more antennas. The wireless network 100 may be configured to use one or more protocols specified in by the Institute of Electrical and Electronics Engineers (IEEE) 802.11™ standards (“IEEE Standard for Wireless LAN Medium Access Control (MAC) and Physical Layer (PHY) Specification. 1999 Edition”, reaffirmed Jun. 12, 2003), such as IEEE 802.11a™-1999; IEEE 802.11b™-1999/CorI2001; IEEE 802. IIg™-2003; and/or IEEE 802.11n™, in the IEEE 802.16™ standards (“IEEE Standard for Local and Metropolitan Area Networks-Part 16: Air Interface for Fixed Broadband Wireless Access System”, Oct. 1, 2004), such as IEEE 802.162004/Corl-2005 or IEEE Std 802.16-2009, which may herein be referred to as the “IEEE Std 802.16-2009” or “WiMAX” standards, and/or in the IEEE 802.15.1™ standards (“IEEE Standard for Local and Metropolitan Area Networks--Specific Requirements. Part 15.1: Wireless Medium Access Control (MAC) and Physical Layer (PHY) Specifications for Wireless Personal Area Networks (WPANs™), Jun. 14, 2005), although the invention is not limited in this respect and other standards may be used. In some embodiments, attributes, compatibility, and/or functionality of wireless network 100 and components thereof may be defined according to, for example, the IEEE 802.16 standards (e.g., which may be referred to as a worldwide interoperability for microwave access (WiMAX)). Alternatively or in addition, the wireless network 100 may use devices and/or protocols that may be compatible with a 3rd Generation Partnership Project (3GPP), Fourth Generation (4G), Long Term Evolution (LTE) cellular network or any protocols for WLANs or WWANs.

Embodiments of the invention may enable the next generation of mobile WiMAX systems (e.g., based on IEEE 802.16m, IEEE 802.16e, IEEE 802.16j, and/or IEEE 802.16ac standards) to efficiently support substantially high mobility and low latency applications, such as, for example, Voice-over-Internet Protocol (VolP), interactive gaming over the air-interface, deployment in larger cell-sizes or lower frequency bands, and/or “multi-hop” relay operations.

Depending on a location in the wireless network 100, a MS 120 will be associated with the serving base station 105 or one or more of the RS 110. For example, a MS 120 proximate to the base station 105 of the wireless network 100 may be directly connected to the serving base station 105 using a transceiver and one, or more antennas while a MS 120 at an edge of the wireless network 100 may be connected to one or more RS 110. In the wireless network 100, the base station 105 provides a base station coverage cell 130 and each RS 110 provides a relay coverage cell 140. The shape and size of each base station coverage cell 130 and relay coverage cell 140 may vary depending on terrestrial and topology characteristics, network requirements, and system configuration.

Each RS 110 is capable of decoding and forwarding signals from a source to a destination through a radio interface. In an embodiment, each RS 110 may be implemented without the need for a wire-line backhaul. Further, the RS 110 may be intelligent and be configured to provide resource scheduling and cooperative relay transmissions whereby one or more of the BS 105 and RS 110 cooperatively transmit or receive data to or from one subordinate station and/or multiple subordinate stations, which may include other BS 105 and/or RS 110. Further, in a cooperative relaying environment, multiple transmitting and/or receiving stations may partner in sharing their antennas to create a virtual antenna array.

Communications in the wireless network 100 may be initiated over a carrier such as a primary carrier. A primary carrier may be a carrier on which BS 105, RS 110, and MS 120 exchange traffic and Physical layer (PHY)/Media Access Control (MAC) layer control information. Further, the primary carrier may be used to communicate control functions for RS 110 and MS 105 operation, such as network entry wherein each MS 120 has a carrier that the MS 120 considers to be its primary carrier in a cell. For communications already established over a primary carrier, a BS 105 or RS 110 may prompt a MS 120 to change from the primary carrier to a secondary carrier, thereafter optionally switching the primary carrier to another carrier. For communications already established over a primary carrier, the BS 105 or RS 110 may also assign a MS 120 to utilize additional radio resources from a secondary carrier.

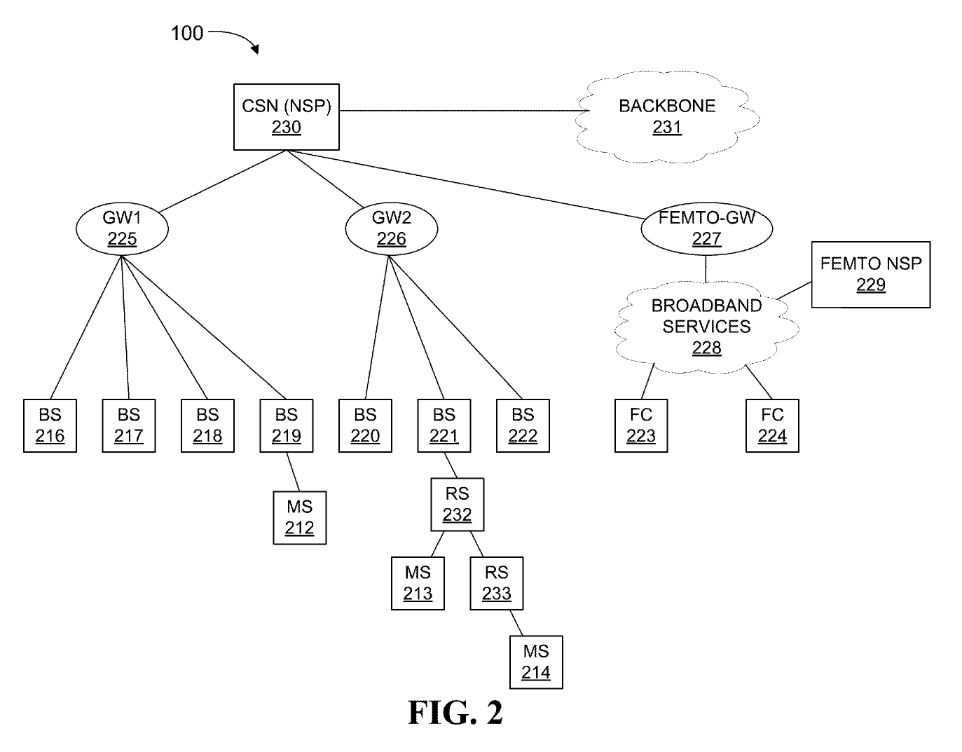

FIG. 2 is an illustration of a wireless network 100 according to some embodiments. A number of BS 216-222 is provided in the wireless network 100 to provide connections for the MS 212-214 directly and/or indirectly through RS 232-233. The BS 216-222 can take a variety of different forms and may cover large or small areas and transmit powers, depending on the application. While the BS(s) and RS(s) are shown as being similar in FIG. 2, they may be connected and configured differently from each other as well. In the illustrated example, the MS 212 is associated with the BS 219. This association allows the MS 212 to communicate with the BS 219 to support all of the services that the MS 212 and the system supports.

Each BS 216-222 is further connected to a gateway (GW) 225, 226. Each gateway supports a number of BSs. The gateways may or may not be connected to each other and are all connected directly or indirectly to a Connectivity Service Network (CSN) for a Network Service Provider (NSP) 230. There may be one or more CSNs in any one system. The CSN is coupled to a telephony backbone 231 that provides access to other telephony systems, data servers and services and more. In some instances a BS may be connected directly to the CSN 230 through the backbone 231 instead of through a gateway.

A third gateway 227 is also connected to the other gateways and to the CSN 230. Femto-GW 227 is a femto gateway to support one or more femtocells (FC) 223, 224. The femtocells are coupled to the Femto-GW 227 through a secure tunnel through broadband services 228. In a typical example, each femtocell is located at a home or small business and is coupled through cable or DSL (Digital Subscriber Line) services to the Femto-GW 227. However, any other broadband service may be used including services of the NSP for the wireless radio system. In that case, the femtocell can connect through a BS 216-222. A second MS 214 is connected to RS 232 through RS 233 and accesses the GW2 226 through BS 221.

In addition to the Femto-GW 227, the FC 223, 224 are also connected through a secure tunnel through the broadband services to a Femto NSP 229. The Femto NSP 229 provides services that are specific to femtocells.

In the illustrated example, system administration and management can be distributed between the BS, GW, Femto NSP 229, and NSP 230 in a variety of different ways. For communications, the MS 212 can communicate with the MS 214 through the respective connected BS and GW. If both MS are registered at the same BS or femtocell, the BS may be able to support communications without routing through the GW. Similarly, if the MS 214 were connected to another system, NSP or ISP (Internet Service Provider), then the two MSs can communicate through the backbone 231. FIG. 2 shows one example network, however, the present invention can be applied to a wide range of different network configurations and communications can be routed differently to suit different situations and applications.

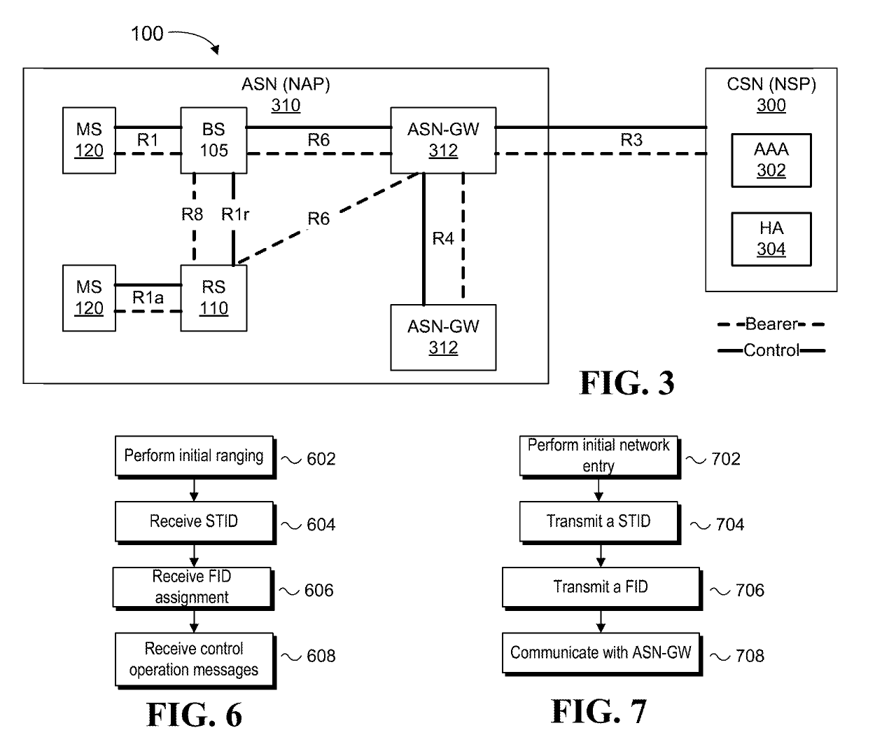

FIG. 3 is a diagram illustrating an interface between a RS 110 and an access service network gateway (ASN-GW) 312 in a distributed control relay architecture, according to some embodiments. The ASN-GW 312 serves as a gateway to the ASN network access provider (NAP) 310. The IEEE 802.16 standard describes medium-access-control (MAC) and physical layer (PHY) protocols for fixed and mobile broadband wireless-access systems. The MAC and PHY functions can be classified into three categories, namely, a data plane, a control plane, and a management plane. The data plane comprises functions in a data processing path such as header compression, as well as MAC and PHY data packet-processing functions. A set of layer-2 (L2) control functions is required to support various radio resource configuration, coordination, signaling, and management. This set of functions is collectively referred to as the control-plane functions. A management plane also is defined for external management and system configuration.

The ASN 310 comprising the BS 105, RS 110, and ASN-GW 312 provide a relatively large cell area for the MS 120 to access the ASN 310. The ASN 310 in this embodiment comprises a number of entities including the BS 105, two ASN-GW 312, the RS 110, and two MS 120, however the embodiment is not so limited. Additional and/or fewer entities may be provided in other embodiments. The ASN-GW 312 are further coupled to the connectivity services network/network services provider CSN (NSP) 300 through an R3 interface. The R3 interface comprises a bearer connection, represented as a dashed line and a control connection represented as a solid line in FIG. 3, between the ASN-GW 312 and the CSN 300 to support AAA 302, policy enforcement and mobility management capabilities. The R3 interface also encompasses bearer plane methods (e.g., tunneling) to transfer IP data between the ASN 310 and the CSN 300. The CSN 300 has an AAA (Authentication, Authorization and Accounting) server 302 and a home agent (HA) 304 for connecting to other wired or wireless networks.

The BS 105 connects to the ASN-GW 312 through a secure tunnel using an R6 interface. The secure tunnel can be through any type of broadband service, including wired and wireless services. The R6 interface between the BS 105 and the ASN-GW 312 in the ASN 310 consists of a set of control and bearer plane protocols for communication between the BS 105 and the ASN-GW 312. The bearer plane consists of intra-ASN data path or inter-ASN tunnels between the BS 105 and ASN-GW 312. The control plane includes protocols for IP tunnel management (establish, modify, and release) in accordance with the MS mobility events. The R6 interface may also serve as a conduit for exchange of MAC states information between neighboring BSs.

Each ASN-GW 312 in the ASN 310 couples to one another through an R4 interface. The R4 interface consists of a set of control and bearer plane protocols originating/terminating in various entities within the ASN 310 that coordinate MS 120 mobility between ASN 310. A first MS 120 interfaces with the BS 105 through an R1 interface per the air interface (PHY and MAC) specifications (IEEE P802.16d/e). The R1 interface may include additional protocols related to the management plane. A second MS 120 interfaces with RS 110 through an R1a interface. The R1a interface consists of a set of control and bearer plane protocols using an over-the-air interface.

The RS 110 interfaces with the ASN-GW 312 over an R6 interface having a bearer plane protocol. The RS 110 also interfaces with the BS 105 over an R1r interface and an R8 interface wherein the R1r interface provides for MS 120 communications and the R8 interface provides for BS 105 and/or RS 110 communications. Not shown, in this embodiment, is an R8 interface situated between two BS 105 or an R1r interface between two RS 110, as in the case of a multi-hop relay. In another embodiment where an LTE protocol is used, one or more types of interfaces may change, (e.g. the R8 interface may be replaced with an X2 interface, the R6 interface may be replaced with an S1 interface, and the R1 interface may be replaced with a Uu interface). Alternate networking protocols may require specific interfaces for the networking protocol that is used.

A MS 120 can perform network entry with the RS 110 in the distributed control relay architecture of the wireless network 100. The MS 120 attaching to the RS 110 uses the same network entry procedures that the MS 120 uses to attach to a BS 105. After performing a ranging operation with the RS 110, the RS 110 and the MS 120 can execute capability negotiation, authentication/key agreement and registration procedures. In an embodiment, the RS 110 communicates with the ASN-GW 312 to facilitate the capability negotiation, authentication/key agreement and registration procedures. The RS 110 communicates with ASN 310 entities using ASN messages during the MS 120 network entry. The RS 110 assigns a station identifier (STID) to the MS 120, wherein the MS 120 is an AMS and the RS 110 is an ARS operating according to a WiMAX IEEE 802.16m protocol. The RS 110 may in addition choose to apply mechanisms to ensure that the STID of the MS 120 is unique in a domain of the BS 105. In this case, the BS 105 is notified by the RS 110 of the assigned STID to the MS 120 via ASN messaging. In an embodiment, STID spaces are independent between a RS cell and a BS cell, such as in 802.16m.

Initial ranging by a MS 120 can be handled by a RS 110 in the distributed control relay architecture, such as that found in the wireless network 100. In an embodiment, the RS 110 allocates its own ranging opportunities and the RS 110 ranging channel configuration is carried in a superframe header (SFH) of the RS 110, which handles the ranging procedure. The RS 110 can receive a range request (AAI_RNG-REQ) message associated with initial network entry of a MS 120. The RS 110 assigns a STID or a temporary STID (TSTID) to the MS 120 in this embodiment and responds back to the MS 120 with a range response (AAI_RNG-RSP) message. The RS 110 uses a mechanism to ensure uniqueness of the TSTID in the BS 105 domain.

Connection management can also be handled by a RS 110 in the distributed control relay architecture. The RS 110 controls connection management for MS 120 associated with the RS 110 such as, AAI_DSx messages can be terminated at the RS 110. The RS 110 performs flow identifier (FID) assignments for the MS 120. The RS 110 communicates with other network entities in the wireless network 100 in a data path (e.g. BS 105, ASN 305 entities, etc.) using ASN 305 messages to complete a data path setup for the FID of the MS 120.

According to embodiments of the invention, the RS 110 is configured to perform operations associated with different control mechanisms such as handoff, security, sleep, and idle. A MS 120 that is associated with the RS 110 is subject to have its control operations performed by the RS 110. During the control operations, the RS 110 communicates directly with the appropriate entities in the ASN 310 that contribute or are linked to each control operation. In this embodiment, there is no direct link between the RS 110 and the ASN-GW 312 or ASN 310, so the R6 interface between the RS 110 and the ASN-GW 312 is via the BS 105. A message sent from the RS 110 can be transported over a path from the RS 110 through the BS 105 to the ASN-GW 312.

A format for the message may be sent using a variety of message types depending on the wireless messaging protocol used. For example, in a WiMAX network based on the IEEE 802.16m standard, control messages associated with the R6 interface between the RS 110 and the ASN-GW 312 are transferred using an L2 transfer message (AAI_L2-XFER). The AAI_L2-XFER message is a generic MAC management message that acts as a generic service carrier for various services including, but not limited to device provisioning bootstrap message to a MS 120, global positioning system (GPS) assistance delivery to the MS 120, BS 105 geo-location unicast delivery to the MS 120, messaging services, etc. The AAI_L2-XFER message is used for IEEE 802.16m messages processed by the ASN-GW 312 or ASN 310.

For R6 messages transferred between the RS 110 and the ASN-GW 312 or ASN 310 that are not processed by the BS 105, the R6 messages are transferred in a RS 110-BS 105 link using the AAI_L2-XFER message. In this embodiment, messages related to control functions of MS 120 associated with the RS 110 are transferred between the RS 110 and the ASN-GW 312 or ASN 310 using the R6 interface. The BS 105 performs a pass through during the message transfer between the RS 110 and the ASN-GW 312 or ASN 310.

Upon the BS 105 receiving a downlink control message from the ASN 310 or ASN-GW 312, the BS 105 performs classification to recognize that the downlink control message is a RS 110 related control message from the ASN 310 or ASN-GW 312. The BS 105 translates the control message between the two interfaces, the R6 and the R1r interfaces, by means of encapsulating the control message in an AAI_L2-XFER MAC management message and sends it to the target RS 110 with flow identifier (FID) =1. In order to optimize the message size, the BS 105 may remove ASN transport network headers from the control messages before transmitting each control message to the RS 110.

On the uplink, the RS 110 sends the control message using an AAI_L2-XFER MAC message on FID =1. Upon the BS 105 receiving the uplink control messages from the RS 110, the BS 105 attaches the ASN transport network headers to the control message and forwards the message to the ASN 310 or ASN-GW 312.

A format for the AAI_L2-XFER message according to the IEEE 802.16m standard may be described as an L2-Xfer Type with the following values:

a) Transfer-Type=1; GNSS assistance (DL)

b) Transfer-Type=2; LBS measurement [Terrestrial meas. and GNSS pseudo ranges] (UL)

c) Transfer-Type=3; Device Bootstrap (DUUL)

d) Transfer-Type=4; WirelessMAN-OFDMA network boundary indication (DL)

e) Transfer-Type=5; ORAT-MSG (DL)

a. Sub-Type=1: GERAN (GSM/GPRS/EGPRS)

b. Sub-Type=2: UTRAN

c. Sub-Type 32 3: E-UTRAN

d. Sub-Type=4: TDSCDMA

e. Sub-Type=5: CDMA2000

f) Transfer-Type=6: SMS

g) Transfer-Type=7: ASN control messages for Relay support (DL/UL)

h) Transfer-Type=8-127; reserved

i) Transfer-Type=128-255; Vendor specific types

To assist a MS 120 attached to one or more RS 110, each RS 110 can broadcast information about neighbor BS 105 and RS 110 that are present in the wireless network 100. A MS 120 attached to a RS 110 may send a scanning report of one or more BS 105 and/or RS 110 that may serve as a potential candidate for handover. The MS 120 attached to the number of RS 110 may follow the scanning procedures as used by the BS 105, such as procedures provided by IEEE 802.16m, with the exception that the RS 110, particularly in an embodiment where the RS 110 is an ARS, defines the corresponding trigger/action, controls the scanning procedure and initiates handover based on a received scanning report.

In the context of WiMAX IEEE involving MS 120 handover and the MS 120 is attached to an RS 110, procedures followed during a handover process are the same as handover procedures used when the MS 120 is attached to a BS 105. During handover, a serving BS 105 or RS 110 may exchange MS 120 context with a target station (BS 105 or RS 110) for handover optimization using ASN messages. The target station shall allocate station identifiers (STID)s and FIDs for the MS 120 during handover. If the target station is a RS 110, the STID and FID allocation occurs as specified according to MS 120 network entry and AMS connection management protocols as specified in IEEE 802.16m.

Further, a distributed control relay architecture also supports security operations. In an embodiment, a RS 110 uses the same security architecture and procedures as a MS 120 to provide privacy, authentication, and confidentiality between itself and the BS 105 on a relay link, such as the relay link with the R1r interface between the RS 110 and the BS 105 in FIG. 3. It may be expected that. RS 110 first behaves like a MS 120 to establish connectivity with BS 105 using an R1 signaling set, including security protection. After that additional RS configuration information, supported by R1r extensions, may be transported via R6/R8 (in L2-Xfer) to the RS 110 to allow RS 110 to operate per network management. The R1r interface is a superset of the R1 a interface, which includes some additional PHY control messages and L2-xfer message.

A RS 110 such as an ARS is operating as distributed security mode. An authentication key (AK) established between the MS 120 and authenticator is derived as follows:

AK=Dot16KDF(PMK, MSID|ARSID|CMAC_KEY_COUNT|“AK”, 160)

The AK may be distributed to the RS 110 during MS 120 authentication or reauthentication with Authenticator (ASN-GW 312).

Sleep operations can be managed in the distributed control relay architecture, such as that found in the wireless network 100. When a MS 120 is attached to a RS 110, the procedures followed during its sleep operation are the same as the sleep procedures used when the MS 120 is attached to a BS 105. Idle mode operation can be managed in the distributed control relay architecture. When the MS 120 is attached to the RS 110, the procedures followed during its idle mode operation are the same operations used when the MS 120 is attached to the BS 105. Deregistration operations can also be managed in the distributed control relay architecture. When the MS 120 is attached to the RS 110, the procedures followed during deregistration with context retention (DCR) operations are the same DCR operations used when the MS 120 is attached to the BS 105. Control message that the RS 110 needs to exchange with the ASN 310 during a control operation may be exchanged using the R6 interface between the RS 110 and the ASN-GW 312.

Additional operations such as an automatic repeat request (ARQ) operations may be managed in the distributed control relay architecture when a MS 120 is attached to a RS 110. The RS 110 performs hop-by-hop operation with the BS 105 in the relay link and the MS 120 in the access link. Hop-by-hop ARQ can mean that two ARQ instances on two links have independent fragmentation/reassembly state maintenance. The next hop ARQ state machine performs ARQ function on in-order data from a previous hop. As an additional option, ARQ feedback for data on the previous hop is sent based on feedback received from a next hop to achieve end-to-end reliability.

The sleep, idle, and deregistration control operations and other operations described in these embodiments are described in reference to the IEEE 802.16m specification. However, these embodiments are not limited to the 802.16m communication protocol and may be applied to additional WiMAX and/or other network communication protocols.

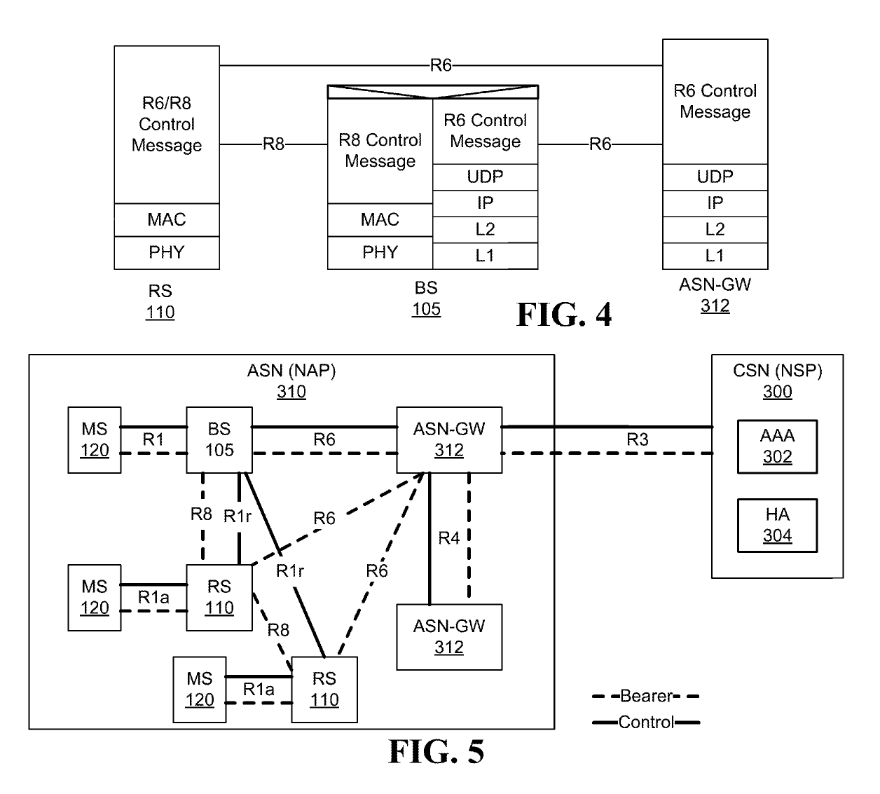

A protocol stack for control message exchange between a MS 120 attached to the RS 110 and the ASN-GW 312 is illustrated in FIG. 4 wherein lower-layer links (e.g. user datagram protocol (UDP)-UDP, IP-IP, L2-L2, etc.) are omitted for clarity. A RS 110, which is an ARS in this embodiment, exchanges a control message over an R6 interface directly with an ASN-GW 312 in the ASN 310. Further, the RS 110 exchanges messages directly with the BS 105 over an R8 interface.

FIG. 5 is a diagram illustrating a distributed control architecture with an interface between RS 110 and an ASN-GW 312 according to some embodiments. An additional RS 110 is provided to exchange messages with the ASN-GW 312. In this embodiment, there is no direct link between the two RS 110. An R8 interface between the two RS 110 is provided through the BS 105 to provide a RS1-BS-RS2 pathway, wherein either of the two RS 110 in FIG. 5 may be RS1 or RS2. An R8 interface is an interface between a BS 105 and another BS 105. The R8 interface allows BS 105 to coordinate their actions without involvement of the ASN-GW 312. When one or more RS 110 are added, the R8 interface can link RS 110 to RS 110 or BS 105 to RS 110. Various methods can be used to transfer R8 control messages between a RS 110 and BS 105. In an embodiment where 802.16m is used as a communication protocol, the control messages associated with the R8 interface between a RS 110 and the BS 105 are transferred using an L2 transfer message (AAI_L2-XFER) message.

As shown in FIG. 5 wherein two RS 110 are connected to the BS 105 and a RS 100 initiates communication using the R8 interface, the RS 110 initiating communications tunnels R8 messages to the BS 105 using the L2 transfer message. The BS 105 tunnels the message using the L2 transfer message to the other RS 110. FIG. 5 illustrates two RS 110 entities, however, additional RS 110 may be provided.

In an embodiment, a MS 120 such as an AMS comprises a transceiver to communicate with an ASN 310 through a RS 110 such as an ARS and over an R6 interface between the ARS and an ASN-GW 312, wherein the MS 120 is configured to interface with the RS 110 to perform initial ranging, to receive a STID, wherein the STID is assigned by the RS 110 to the MS 120, to receive a flow identifier assignment from the RS 110, and to receive control operations messages from the RS 110, wherein the control operations are performed by the RS 110. The RS 110 may transmit the STID to a BS 105 such an advanced base station (ABS) coupled to the RS 110. The MS 120 may be configured to execute capability negotiation, authentication/key agreement, and registration procedures with the RS 110. The MS 120 may transmit a range request (AAI_RNG-REQ) message to the RS 110 during initial ranging. The control operations may comprise handover, security, sleep, and idle control operations. The MS 120 may communicate through the ARS using an R1a interface with control plane and bearer plane protocols. Further, the STID may be a temporary STID. The MS 120 may be configured to receive a STID and a FID from the RS 110 during a handover operation.

In an embodiment, a RS 110 such as an ARS comprises a transceiver to communicate with a MS 120 such as an AMS, a BS 105 such as an ABS and an ASN-GW 312, wherein the RS 110 is configured to interface with the MS 120 to perform initial ranging, to transmit a STID assigned by the RS 110 to the MS 120, to transmit a flow identifier assigned by the RS 110 to the MS 120, and to communicate with the ASN-GW over an R6 interface through the BS 105. The RS 110 also may transfer control messages between the RS 110 and the ASN-GW over the R6 interface and between the RS 110 and the BS 105 or a second RS 110 over an R8 interface. Further, the control messages may be formatted as L2 transfer messages (AAI_L2-XFER). The control messages received from the ASN-GW by the RS 110 may have transport headers removed by the BS 105 and the control functions comprise sleep operations, idle mode operation, and deregistration operations. Further, the RS 110 may manage control functions for the MS 120.

FIG. 6 is a diagram illustrating a method of distributed relay control according to some embodiments. In this figure, a method for wireless networking in a distributed control architecture using a MS 120 such as an AMS comprises performing initial ranging (element 602) with a RS 110 such as an ARS by transmitting a range request (AAI_RNG-REQ) message from the MS 120 to the RS 110, receiving a STID (element 604) from the RS 110, wherein the STID is assigned to the MS 120 by the RS 110, receiving a FID assignment from the RS 110 (element 606), wherein the FID is assigned to the AMS by the RS 110; and receiving control operation messages (element 608) from the RS 110, wherein the control operations are performed by the RS 110. Further, the MS 120 may communicate through the RS 110 using an R1a interface. The MS 120 may communicate with an access service network 310 through the RS 110 and over an R6 interface between RS 110 and an access service network gateway (ASN-GW) 312.

FIG. 7 is a diagram illustrating a method of distributed relay control according to some embodiments. In this figure, a method for wireless networking in a distributed control architecture using a RS 110 such as an ARS comprises performing initial network entry (element 702) with a MS 120 such as an AMS, transmitting a STID (element 704) assigned by the RS 110 to the MS 120, transmitting a FID assigned by the RS 110 to the MS 120 (element 706), and communicating with an ASN-GW 312 over an R6 interface through a 105 BS (element 708). Further, the RS 110 may manage control functions for the MS 120 wherein the control functions comprise sleep operations, idle mode operation, and deregistration operations. The RS 110 may communicate with the ASN-GW 312 directly over the R6 interface. The BS 105 may perform routing optimization on data or signals transferred through the BS 105.

The operation discussed herein may be generally facilitated via execution of appropriate firmware or software embodied as code instructions on tangible media as applicable. Thus, embodiments of the invention may include sets of instructions executed on some form of processing core or otherwise implemented or realized upon or within a machine-readable medium. A machine-readable medium includes any mechanism for storing or transmitting information in a form readable by a machine (e.g., a computer). For example, a machine-readable medium can include an article of manufacture such as a read only memory (ROM); a random access memory (RAM); a magnetic disk storage media; an optical storage media; and a flash memory device, etc. In addition, a machine-readable medium may include propagated signals such as electrical, optical, acoustical or other form of propagated signals (e.g., carrier waves, infrared signals, digital signals, etc.).

While certain features of the invention have been illustrated and described herein, many modifications, substitutions, changes, and equivalents will now occur to those skilled in the art. It is, therefore, to be understood that the appended claims are intended to cover all such modifications and changes as fall within embodiments of the invention.

What is claimed is:

1. An advanced mobile station (AMS) comprising a transceiver to communicate with an access service network (ASN) through an advanced relay station (ARS) and over an R6 interface between the ARS and an ASN gateway (GW), wherein the AMS is configured to interface with the ARS to perform initial ranging, to receive a station identifier (STID) wherein the STID is assigned by the ARS to the AMS, to receive a flow identifier assignment from the ARS, and to receive control operations messages from the ARS, wherein the control operations are performed by the ARS.

2. The AMS of claim 1, wherein the ARS transmits the STID to an advanced base station (ABS) coupled to the ARS.

3. The AMS of claim 1, wherein the AMS is further configured to execute capability negotiation, authentication/key agreement, and registration procedures with the ARS.

4. The AMS of claim 1, further comprising transmitting a range request (AAI_RNG-REQ) message to the ARS during initial ranging.

5. The AMS of claim 1, wherein the control operations comprise handover, security, sleep, and idle control operations.

6. The AMS of claim 1, wherein the AMS communicates through the ARS using an R1 a interface with control plane and bearer plane protocols.

7. The AMS of claim 1, wherein the STID is a temporary STID (TSTID).

8. The AMS of claim 5, wherein the AMS is configured to receive a STID and a flow identifier from the ARS during a handover operation.

9. A method for wireless networking in a distributed control architecture using an advanced mobile station (AMS), comprising:
performing initial ranging with an advanced relay station (ARS) by transmitting a range request (AAI_RNG-REQ) message from the AMS to the ARS;
receiving a station identifier (STID) from the ARS, wherein the STID is assigned to the AMS by the ARS;
receiving a flow identifier (FID) assignment from the ARS, wherein the FID is assigned to the AMS by the ARS; and
receiving control operation messages from the ARS, wherein the control operations are performed by the ARS.

10. The method of claim 9, wherein the AMS communicates through the ARS using an R1a interface.

11. The method of claim 9, wherein the AMS communicates with an access service network through the ARS and over an R6 interface between ARS and an access service network gateway (ASN-GW).

12. An advanced relay station (ARS) comprising a transceiver to communicate with an advanced mobile station (AMS), an advanced base station (ABS) and an access service network gateway (ASN-GW), wherein the ARS is configured to interface with the AMS to perform initial ranging, to transmit a station identifier (STID) assigned by the ARS to the AMS, to transmit a flow identifier assigned by the ARS to the AMS, and to communicate with the ASN-GW over an R6 interface through the ABS.

13. The ARS of claim 12, further comprising transferring control messages between the ARS and the ASN-GW over the R6 interface and between the ARS and the ABS or a second ARS over an R8 interface.

14. The ARS of claim 13, wherein the control messages are formatted as L2 transfer messages (AAI_L2-XFER).

15. The ARS of claim 14, wherein transport headers are removed, from control messages received from the ASN-GW, by the ABS.

16. The ARS of claim 12, further comprising managing control functions for the AMS.

17. The ARS of claim 16, wherein the control functions comprise sleep operations, idle mode operation, and deregistration operations.

18. A method for wireless networking in a distributed control architecture using an advanced relay station (ARS), comprising:
performing initial network entry with an advanced mobile station (AMS);
transmitting a station identifier (STID) assigned by the ARS to the AMS;
transmitting a flow identifier (FID) assigned by the ARS to the AMS, and;
communicating with an access service network gateway (ASN-GW) over an R6 interface through an ABS.

19. The method of claim 18, further comprising managing control functions for the AMS.

20. The method of claim 19, wherein the control functions comprise sleep operations, idle mode operation, and deregistration operations.

21. The method of claim 18, wherein the ARS communicates with the ASN-GW directly over the R6 interface.

22. The method of claim 18, wherein the ABS performs routing optimization on data transferred through the ABS.
